(19) United States
(12) Patent Application Publication
(10) Pub. No.: US 2026/0221532 A1
(43) Pub. Date: Jul. 30, 2026

(54) ADAPTIVE SELF-HEATING BATTERY CELLS INCORPORATING A NEGATIVE TEMPERATURE COEFFICIENT MATERIAL

(71) Applicant: GM GLOBAL TECHNOLOGY OPERATIONS LLC, Detroit, MI (US)

(72) Inventors: Dewen KONG, Shanghai (CN); Jingyuan LIU, Shanghai (CN); Haijing LIU, Shanghai (CN); Yuan LI, Shanghai (CN); Dave Gerard RICH, Sterling Heights, MI (US)

(21) Appl. No.: 19/414,439

(22) Filed: Dec. 10, 2025

(30) Foreign Application Priority Data
Jan. 25, 2025 (CN) 2025101254944

(51) Int. Cl. H01M 10/637; H01M 4/13; H01M 4/62; H01M 10/615; H01M 4/02

(52) U.S. Cl. CPC H01M 10/637; H01M 4/13; H01M 4/62; H01M 10/615; H01M 2004/021; H01M 2004/027; H01M 2004/028

(57) ABSTRACT

A battery cell includes C cathode electrodes including a cathode active material layer arranged on a cathode current collector, A anode electrodes including an anode active material layer arranged on an anode current collector, and S separators, where C, A, and S are integers. In some examples, at least one of the C cathode electrodes and the A anode electrodes includes a negative temperature coefficient (NTC) material. In other examples, a resistive heating layer is arranged adjacent to at least one of the C cathode electrodes and the A anode electrodes and includes a layer including a negative temperature coefficient (NTC) material arranged on an electrode. The NTC material is selected from a group consisting of a metal oxide with a spinel structure, nickel-chromium (Ni-Cr) oxide, a copper-nickel (Cu-Ni) oxide ceramic including a metal oxide, and combinations thereof.

### CROSS-REFERENCE TO RELATED APPLICATIONS

This application claims the benefit of Chinese Patent Application No. 202510125494.4, filed on January 26, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to adaptive self-heating battery cells incorporating a negative temperature coefficient material.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes including a cathode active material layer arranged on a cathode current collector, A anode electrodes including an anode active material layer arranged on an anode current collector, and S separators, where C, A, and S are integers. At least one of the C cathode electrodes and the A anode electrodes includes a negative temperature coefficient (NTC) material.

In other features, at least one of the anode active material layer includes the NTC material and the cathode active material layer includes the NTC material. The NTC material comprises in a range from 0.5 wt% to 40 wt% of the at least one of the cathode active material layer and the anode active material layer.

In other features, a resistive heating layer including the NTC material is arranged at least one of between the cathode active material layer and the cathode current collector, between the anode active material layer and the anode current collector, on an outer surface of the cathode active material layer, and on an outer surface of the anode active material layer.

In other features, the resistive heating layer includes a conductive carbon in a range from 30 wt% to 70 wt%, a polymer in a range from 40 wt% to 60 wt%, and the NTC material in a range from 20 wt% to 30 wt%.

In other features, the NTC material is selected from a group consisting of a metal oxide with a spinel structure, nickel-chromium (Ni-Cr) oxide, a copper-nickel (Cu-Ni) oxide ceramic including a metal oxide, and combinations thereof. The cathode active material layer includes cathode active material selected from a group consisting of an olivine compound, a rock salt layered oxide, a spinel, a tavorite compound, and combinations thereof. The anode active material layer includes anode active material selected from a group consisting of a carbonaceous material, lithium titanium oxide, a metal oxide, a metal sulfide, Si, silicon-alloy, Si-graphite, lithiated Si, and combinations thereof.

In other features, loading of the NTC material in the one of the cathode active material layer and the anode active material layer is in a range from 0.5 to 4.4 mAh/cm². Porosity of the one of the cathode active material layer and the anode active material layer including the NTC material is in a range from 25 % to 50 %.

A battery cell includes C cathode electrodes including a cathode active material layer arranged on a cathode current collector, A anode electrodes including an anode active material layer arranged on an anode current collector, and S separators, where C, A, and S are integers. A resistive heating layer is arranged adjacent to at least one of the C cathode electrodes and the A anode electrodes and includes a layer including a negative temperature coefficient (NTC) material arranged on an electrode.

In other features, the resistive heating layer includes a conductive carbon in a range from 30 wt% to 70 wt%, a polymer adhesive in a range from 40 wt% to 60 wt%, and the NTC material in a range from 20 wt% to 30 wt%.

In other features, a switch is configured to selectively short the electrode of the resistive heating layer to one of the cathode current collector and the anode current collector. The electrode of the resistive heating layer is connected to the cathode current collector of at least one of the C cathode electrodes. The electrode of the resistive heating layer is connected to the anode current collector of at least one of the A anode electrodes.

In other features, the NTC material is selected from a group consisting of a metal oxide with a spinel structure, nickel-chromium (Ni-Cr) oxide, a copper-nickel (Cu-Ni) oxide ceramic including a metal oxide, and combinations thereof. The cathode active material layer includes cathode active material selected from a group consisting of an olivine compound, a rock salt layered oxide, a spinel, a tavorite compound, and combinations thereof. The anode active material layer includes anode active material selected from a group consisting of a carbonaceous material, lithium titanium oxide, a metal oxide, a metal sulfide, Si, silicon-alloy, Si-graphite, lithiated Si, and combinations thereof.

In other features, a thickness of the resistive heating layer is in a range from 0.5 μm to 50 μm. The resistive heating layer has a thickness in a range from 1 μm to 3 μm and the electrode has a thickness in a range from 1 μm to 10 μm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a cross section of an example of a battery cell including C cathode electrodes, A anode electrodes, and S separators and incorporating a negative temperature coefficient (NTC) material according to the present disclosure;

FIG. 1B is a graph illustrating an example of resistance as a function of temperature for a negative temperature coefficient (NTC) material;

FIGS. 2A to 2C are side cross sections of examples of cathode electrodes integrating NTC material according to the present disclosure;

FIG. 2D is a side cross section of an example of a cathode electrode that does not include NTC material;

FIGS. 3A to 3C are side cross sections of examples of anode electrodes integrating NTC material according to the present disclosure;

FIG. 3D is a side cross section of an example of an anode electrode that does not include NTC material;

FIG. 4A is a side cross section of an example of the resistive heating layer including a layer including NTC material arranged on opposite sides of an electrode according to the present disclosure;

FIG. 4B is a side cross section of an example of the resistive heating layer arranged between a separator and a cathode electrode according to the present disclosure;

FIG. 4C is a side cross section of an example of the resistive heating layer arranged between a separator and an anode electrode according to the present disclosure;

FIG. 5A is a side cross section of an example of the resistive heating layer arranged between a cathode electrode and an anode electrode and switches connecting electrodes thereof according to the present disclosure;

FIG. 5B is a side cross section of an example of the resistive heating layer arranged between a cathode electrode and an anode electrode, switches selectively connecting one of the electrodes to the resistive heating layer, and a shunt according to the present disclosure;

FIG. 6A illustrates an example of an electrode including an active material layer including NTC material with a homogenous concentration in a longitudinal direction according to the present disclosure;

FIG. 6B illustrates an example of an electrode including an active material layer including NTC material with an increasing concentration in a longitudinal direction according to the present disclosure; and

FIG. 6C is a graph illustrating an example of an increasing concentration in a longitudinal direction away from the external tab according to the present disclosure.

In the drawings, reference numbers may be reused to identify similar and/or identical elements.

### DETAILED DESCRIPTION

While the battery cells are described herein in the context of vehicles, the battery cells can be used in other mobile or stationary applications.

Battery cells can be used as accessory batteries (e.g., 12 V batteries). Battery cells can also be used in battery modules or packs supplying power to a propulsion motor in battery electric vehicles (BEVs). The battery cells include cathode electrodes with cathode active materials (such as lithium iron phosphate (LFP)) that may have reduced performance at lower temperatures (e.g., -30 °C). The present disclosure relates to battery cells supporting adaptive self-heating by incorporating a negative temperature coefficient (NTC) material (e.g., (MnCoNiCu)₂O₄) integrated into an active material layer of an electrode or in a separate resistive heater layer arranged adjacent to an electrode.

The NTC material exhibits higher ohmic resistance at cold temperatures (e.g., -30 °C) and lower ohmic resistance at higher temperatures (e.g., greater than -4 °C). When current is supplied, the resistance of the NTC material serves as an embedded heater at lower temperatures to quickly warm the battery cell. As the temperature of the battery cell increases, the resistance of the NTC material decreases to less than the resistance of the bulk electrode.

The NTC material maintains the temperature of the battery cell above a predetermined temperature (such as -4°C) without sacrificing power performance (since the resistance is lower at higher temperatures). When operating at warmer temperatures, the lower resistance of the NTC material allows the NTC material to serve as a conductive filler to reduce electrode resistance and enhance battery cell power capability.

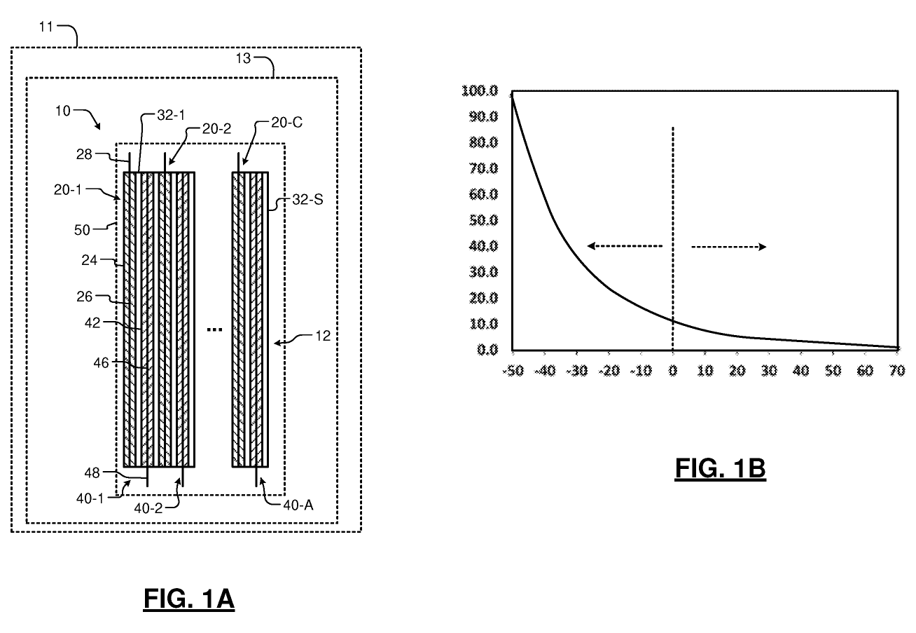

Referring now to FIG. 1A, a battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the battery cell 10. The battery cell stack 12 is arranged in an enclosure 50.

The C cathode electrodes 20-1, 20-2, ..., and 20-C include a cathode active material layer 24 on one or both sides of a cathode current collector 26. The A anode electrodes 40-1, 40-2, ..., and 40-A include an anode active material layer 42 arranged one or both sides of an anode current collector 46.

During charging/discharging, the A anode electrodes 40 and the C cathode electrodes 20 exchange lithium ions. In some examples, the cathode active material layers 24 and/or anode active material layers 42 comprise coatings including one or more active materials, solid electrolytes, one or more conductive additives, and/or one or more binder materials that are applied to the current collectors.

In some examples, the anode current collectors 46 and/or the cathode current collectors 26 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

As will be described further below, the battery cell 10 incorporates negative temperature coefficient (NTC) material in active material layers of one or both the electrodes, as a layer within or adjacent to the electrodes, or as a separate resistive heating layer. In some examples, the battery cell 10 has a stacked cell architecture for a prismatic or pouch formats. In other examples, the battery cell has a winding cell architecture for prismatic, pouch, or cylindrical formats.

Referring now to FIG. 1B, the resistance of the NTC material (e.g., (MnCoNiCu)₂O₄) increases as temperature decreases. Below approximately 0 ºC, the NTC material has a resistance that is greater than the bulk resistance of the electrode to provide increased resistance and heating of the electrode. In some examples, the NTC material has a resistance that is less than or equal to the electrode bulk resistance above a predetermined temperature (such as 0 ºC or room temperature).

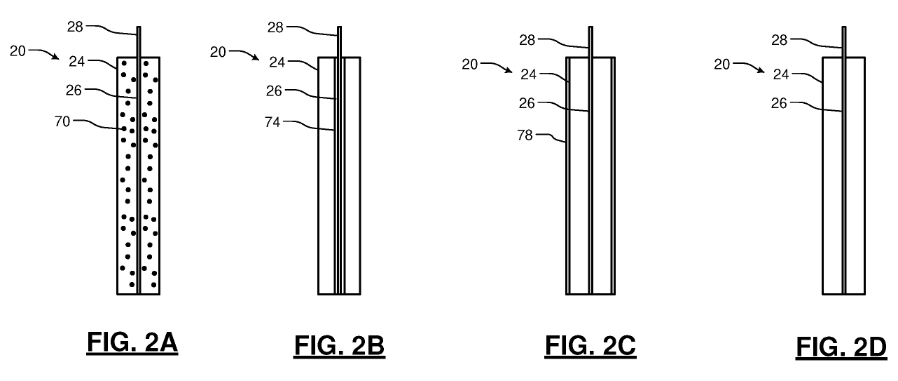

Referring now to FIGS. 2A to 2D, examples of the C cathode electrodes 20 are shown. In FIG. 2A, NTC material 70 is added to the cathode active material layer 24 of the C cathode electrodes 20 during manufacturing. In some examples, the cathode active material layer 24 also includes cathode active material, a conductive filler, and/or a binder.

In FIG. 2B, a resistive heating layer 74 including the NTC material is arranged on the cathode current collector 26 between the cathode active material layer 24 and the cathode current collector 26. In some examples, the resistive heating layer 74 includes a conductive filler, a polymer adhesive, and the NTC material. In FIG. 2C, a resistive heating layer 78 is arranged on an outer surface of the cathode current collector 26.

In FIG. 2D, the C cathode electrodes 20 are standard electrodes without NTC material and the NTC material is arranged in an anode electrode or as a separate resistive heating layer including the NTC material in another location.

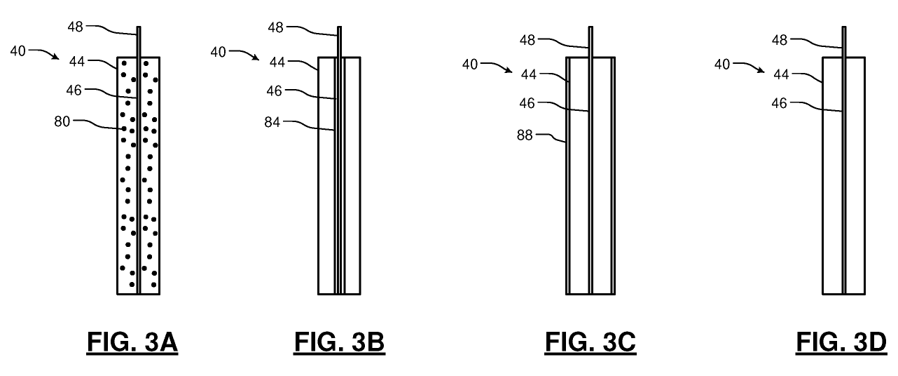

Referring now to FIGS. 3A to 3D, examples of the A anode electrodes 40 is shown. In FIG. 3A, an NTC material 80 is added to the anode active material layer 44. In some examples, the anode active material layer 44 includes anode active material, a conductive filler, and/or a binder.

In FIG. 3B, a resistive heating layer 84 including the NTC material is arranged on the anode current collector 46 between the anode active material layer 44 and the anode current collector 46. In FIG. 3C, a resistive heating layer 88 is arranged on an outer surface of the anode current collector 46. In some examples, the resistive heating layers 84 and 88 include a conductive filler, a polymer adhesive, and the NTC material.

In FIG. 3D, the A anode electrodes 40 are standard electrodes without NTC material and the NTC material is arranged in a cathode electrode and/or as a separate resistive heating layer including the NTC material in another location.

As can be appreciated, the battery cell can include any combination of electrodes set forth herein. For example, any one of the cathode electrodes in FIGS. 2A to 2D can be used with any one of the anode electrodes of FIGS. 3A to 3D. If the cathode electrode of FIG. 2D is used with the anode electrode of FIG. 3D, the NTC material can be added as a separate resistive heating layer including NTC material as described below.

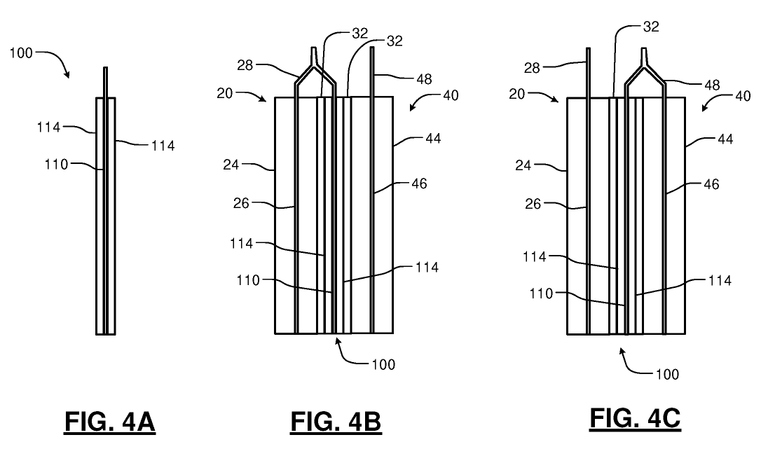

Referring now to FIGS. 4A to 4C, a separate resistive heating layer including NTC material can be used (e.g., separate from the anode and cathode electrodes). In FIG. 4A, a resistive heating layer 100 including the NTC material is inserted into the battery cell stack. For example, the resistive heating layer 100 includes an electrode 110 and a layer 114 including the NTC material arranged on one or both sides of the electrode 110. In some examples, the layers 114 include the NTC material, conductive carbon, and a polymer adhesive. In FIG. 4B, the electrode 110 can be shorted to the cathode current collector 26 of one of the C cathode electrodes 20. In FIG. 4C, the electrode 110 can be shorted to the anode current collector 46 of one of the A anode electrodes 40.

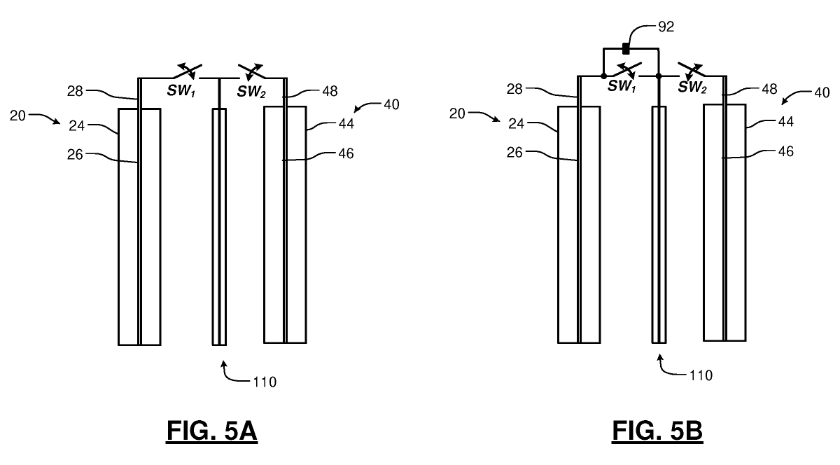

Referring now to FIGS. 5A and 5B, switches SW 1 and/or SW 2 can be used to selectively connect and disconnect the electrodes of the resistive heating layers to an adjacent anode current collector or cathode current collector, respectively. The switches SW 1 and/or SW 2 include terminals selectively connecting a cathode current collector of one of the C cathode electrodes 20 to the electrode 110 of the electrode 110 (or an anode current collector of one of the A anode electrodes 40 to the electrode 110 of the resistive heating layer 100). One of the switches SW 1 and SW 2 is selectively closed to connect the electrode 110 of the resistive heating layer 100 to the current collector of the cathode electrode or anode electrode, respectively. In FIG. 5B, one or more shunts 92 are arranged in parallel across one or both of the switches SW 1 and SW 2 to divert excess current.

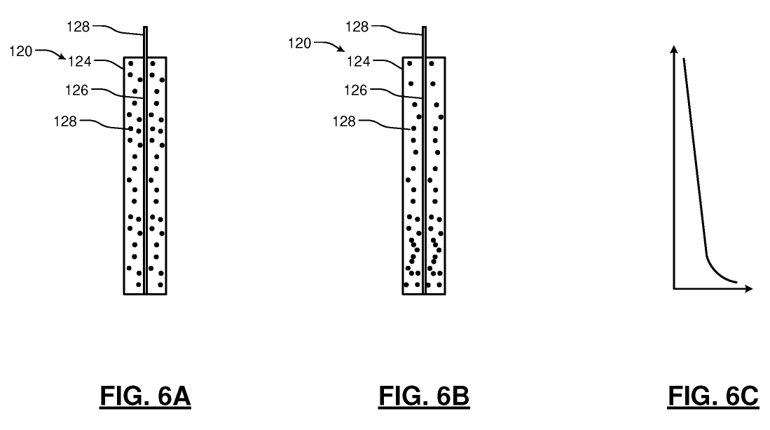

Referring now to FIGS. 6A to 6C, an electrode 120 (e.g., an anode or cathode electrode) includes a current collector 126. An active material layer 124 is arranged on one or both sides of the current collector 126. The active material layer 124 includes active material mixed with NTC material 128, a conductive filler, and/or a binder. In FIG. 6B, the concentration of the NTC material 128 is approximately homogenous or uniform. In FIG. 6C, the concentration of the NTC material 128 increases from one longitudinal end (e.g., near the external tab) to the opposite longitudinal end. A similar approach can be used for the separate resistive heating layer.

In some examples, the cathode active material is selected from a group consisting of an olivine compound, a rock salt layered oxide, a spinel, a tavorite compound, and combinations thereof. Examples of olivine compounds include LiV₂(PO₄)₃, LiFePO₄ (LFP), LiCoPO₄, and LiMnPO₄. Examples of rock salt layered oxides include LiNiₓMn_{y}Co_{1-x-y}O₂, LiNiₓMn₁₋ₓO₂, and Li₁₊ₓMO₂ (e.g., NMC111, NMC523, NMC622, NMC721). Examples of spinel include LiMn₂O₄. Examples of tavorite compounds include LiVPO₄F.

In some examples, the anode active material is selected from a group consisting of a carbonaceous anode ((e.g., graphite, graphene), silicon (Si)/graphite, silicon oxide (SiOₓ)/graphite, or Si alloy/graphite), lithium titanium oxide (e.g. Li₄Ti₅O₁₂), metal oxide (e.g., vanadium oxide (V₂O₅), tin oxide (SnO), cobalt oxide (Co₃O₄)), metal sulfide (e.g., FeS), Si, silicon-alloy, Si-graphite, lithiated Si, and combinations thereof.

In some examples, the conductive fillers are selected from a group consisting of carbon-based materials, oxides, carbides, and silicides. Examples of carbon-based materials include carbon black, graphite, graphene, graphene oxide, Super P, acetylene black, carbon nanofibers, carbon nanotubes and combinations thereof. Examples of oxides include simple oxides such as ruthenium oxide (RuO₂), tin oxide (SnO₂), zinc oxide (ZnO), and germanium oxide (Ge₂O₃), and superconductive oxides such as yttrium barium copper oxide (YBa₂Cu₃O₇) or lanthanum calcium manganese oxide (La_{0.75}Ca_{0.25}MnO₃). Examples of carbides include SiC₂. Examples of silicides include MoSi₂.

Examples of NTC materials include inorganic materials such as metal oxides with spinel structure (e.g., (MnCoNiCu)₂O₄, (MnCoNi)₂O₄), Ni-Cr oxide and Cu-Ni oxide ceramics composed of metal oxides such as manganese oxide (MnO₂), nickel oxide (NiO), cobalt oxide (Co₂O₃), and iron oxide (Fe₂O₃). In some examples, the NTC material has a resistance at room temperature (RT) that is less than 50 ohm.m. In some examples, the NTC material has a resistance at room temperature (RT) that is less than 5ohm.m.

In some examples, the battery cell uses liquid electrolyte. In other examples, the battery cell is semi-solid state. Examples of liquid electrolytes include a solvent and one or more lithium salts selected from a group consisting of lithium bis(oxalato)borate (LiBOB), lithium oxalyldifluoroborate (LiODFB), lithium fluoroalkylphosphate (LiFAP), LiPF₆, LiAsF₆, LiBF₄, LiClO₄, LiCF₃SO₃, LiTFSI, Lithium bis(fluorosulfonyl)imide (LiFSI), lithium bis-trifluoromethanesulfonimide (LITFSI), and combinations thereof.

In some examples, the electrodes include an active material layer including NTC material with a loading in a range from 0.5 to 4.4 mAh/cm². In some examples, the active material layer includes NTC material with a loading in a range from 0.9 to 2 mAh/cm². In some examples, the NTC material in the active material layer comprises 0.5 wt% to 30 wt%. In some examples, the NTC material in the active material layer comprises 3 wt% to 10 wt%. In some examples, a press density is in a range from 1.5 g/cc to 3.6 g/cc. In some examples, a porosity of the active material layer is in a range from 25 % to 50 %.

In some examples, the resistive heating layer comprises conductive carbon in a range from 30 wt% to 70 wt%. In some examples, the resistive heating layer comprises conductive carbon in a range from 40 wt% to 60 wt%. In some examples, the resistive heating layer comprises hot adhesive polymer in a range from 10 wt% to 40 wt%. In some examples, the resistive heating layer comprises hot adhesive polymer in a range from 20 wt% to 30 wt%. In some examples, the resistive heating layer comprises NTC material in a range from 5 wt% to 30 wt%. In some examples, the resistive heating layer comprises NTC material in a range from 10 wt% to 20 wt%.

In some examples, the resistive heating layer has a thickness in a range from 0.5 μm to 50 μm. In some examples, the resistive heating layer has a thickness in a range from 1 μm to 3 μm. In some examples, the electrode of the resistive heating layer has a thickness in a range from 1 μm to 10 μm.

In some examples, the current collectors are selected from a group consisting of solid metal foil, meshed foil, and 3D metal foam. In some examples, the current collectors have a thickness in a range from 4 μm to 30 μm. In some examples, the current collectors have a thickness in a range from 6 μm to 15 μm. In some examples, the cathode current collector comprises aluminum (Al) or stainless steel. In some examples, the anode current collector comprises copper (Cu).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
C cathode electrodes including a cathode active material layer arranged on a cathode current collector;
A anode electrodes including an anode active material layer arranged on an anode current collector; and
S separators, where C, A, and S are integers,
wherein at least one of the C cathode electrodes and the A anode electrodes includes a negative temperature coefficient (NTC) material.

2. The battery cell of claim 1, wherein at least one of:
the anode active material layer includes the NTC material; and
the cathode active material layer includes the NTC material.

3. The battery cell of claim 2, wherein the NTC material comprises in a range from 0.5 wt% to 40 wt% of the at least one of the cathode active material layer and the anode active material layer.

4. The battery cell of claim 1, wherein a resistive heating layer including the NTC material is arranged at least one of:
between the cathode active material layer and the cathode current collector;
between the anode active material layer and the anode current collector;
on an outer surface of the cathode active material layer; and
on an outer surface of the anode active material layer.

5. The battery cell of claim 4, wherein the resistive heating layer includes:
a conductive carbon in a range from 30 wt% to 70 wt%;
a polymer in a range from 40 wt% to 60 wt%; and
the NTC material in a range from 20 wt% to 30 wt%.

6. The battery cell of claim 1, wherein the NTC material is selected from a group consisting of a metal oxide with a spinel structure, nickel-chromium (Ni-Cr) oxide, a copper-nickel (Cu-Ni) oxide ceramic including a metal oxide, and combinations thereof.

7. The battery cell of claim 1, wherein the cathode active material layer includes cathode active material selected from a group consisting of an olivine compound, a rock salt layered oxide, a spinel, a tavorite compound, and combinations thereof.

8. The battery cell of claim 1, wherein the anode active material layer includes anode active material selected from a group consisting of a carbonaceous material, lithium titanium oxide, a metal oxide, a metal sulfide, Si, silicon-alloy, Si-graphite, lithiated Si, and combinations thereof.

9. The battery cell of claim 2, wherein loading of the NTC material in the one of the cathode active material layer and the anode active material layer is in a range from 0.5 to 4.4 mAh/cm2.

10. The battery cell of claim 2, wherein porosity of the one of the cathode active material layer and the anode active material layer including the NTC material is in a range from 25 % to 50 %.

11. A battery cell comprising:
C cathode electrodes including a cathode active material layer arranged on a cathode current collector;
A anode electrodes including an anode active material layer arranged on an anode current collector; and
S separators, where C, A, and S are integers,
a resistive heating layer arranged adjacent to at least one of the C cathode electrodes and the A anode electrodes and including a layer including a negative temperature coefficient (NTC) material arranged on an electrode.

12. The battery cell of claim 11, wherein the resistive heating layer includes:
a conductive carbon in a range from 30 wt% to 70 wt%;
a polymer adhesive in a range from 40 wt% to 60 wt%; and
the NTC material in a range from 20 wt% to 30 wt%.

13. The battery cell of claim 11, further comprising a switch configured to selectively short the electrode of the resistive heating layer to one of the cathode current collector and the anode current collector.

14. The battery cell of claim 11, wherein the electrode of the resistive heating layer is connected to the cathode current collector of at least one of the C cathode electrodes.

15. The battery cell of claim 11, wherein the electrode of the resistive heating layer is connected to the anode current collector of at least one of the A anode electrodes.

16. The battery cell of claim 11, wherein the NTC material is selected from a group consisting of a metal oxide with a spinel structure, nickel-chromium (Ni-Cr) oxide, a copper-nickel (Cu-Ni) oxide ceramic including a metal oxide, and combinations thereof.

17. The battery cell of claim 11, wherein the cathode active material layer includes cathode active material selected from a group consisting of an olivine compound, a rock salt layered oxide, a spinel, a tavorite compound, and combinations thereof.

18. The battery cell of claim 11, wherein the anode active material layer includes anode active material selected from a group consisting of a carbonaceous material, lithium titanium oxide, a metal oxide, a metal sulfide, Si, silicon-alloy, Si-graphite, lithiated Si, and combinations thereof.

19. The battery cell of claim 12, wherein a thickness of the resistive heating layer is in a range from 0.5 μm to 50 μm.

20. The battery cell of claim 12, wherein the resistive heating layer has a thickness in a range from 1 μm to 3 μm and the electrode has a thickness in a range from 1 μm to 10 μm.
